(19) United States
(12) Patent Application Publication
(10) Pub. No.: US 2024/0146076 A1
(43) Pub. Date: May 2, 2024

(54) ELECTRONIC DEVICE AND CHARGING METHOD THEREOF

(71) Applicant: ASUST eK COMPUTER INC., Taipei City (TW)

(72) Inventor: Yu-Lian Lin, Taipei City (TW)

(73) Assignee: ASUST eK COMPUTER INC., Taipei City (TW)

(21) Appl. No.: 18/341,786

(22) Filed: Jun. 27, 2023

(30) Foreign Application Priority Data
Oct. 28, 2022 (TW) 111141024

(51) Int. Cl. H02J 7/00

(52) U.S. Cl. CPC H02J 7/0029; H02J 7/00712

(57) ABSTRACT

An electronic device and a charging method thereof are provided. The method is adapted to the electronic device including a battery module, and the charging method includes: determining whether the electronic device is in a battery mode; and in response to the electronic device being in the battery mode, determining a current system state of the electronic device and accordingly setting a corresponding power consumption threshold value.

### CROSS-REFERENCE TO RELATED APPLICATION

This application claims the priority benefit of Taiwan application serial no. 111141024, filed on Oct. 28, 2022. The entirety of the above-mentioned patent application is hereby incorporated by reference herein and made a part of this specification.

### BACKGROUND

### Technical Field

The disclosure relates to an electronic device that dynamically adjusts a power consumption limit and a charging method thereof.

### Description of Related Art

In applications of the universal serial bus (USB) of Type-C/A specification, USB ports on notebook computers may supply power to connected external devices for charging, thus providing users with higher convenience.

During the charging process of the external device through the USB port, abnormal conditions such as short circuit of the devise and component damage on the charging path may occur. These abnormal conditions generate an output current higher than a rating on the path from the battery port to the external device port, resulting in a destruction of the component of the device. In order to prevent the occurrence of this phenomenon, conventional batteries have a protection mechanism for the output current, thereby cutting off the transmission path for protection when the output current is too large. However, the threshold value set by the protection mechanism of the battery cannot be fully adapted to the output current under different system states, so that the component of the device is still in danger of being damaged without triggering the protection mechanism. The damage may be widened over time.

### SUMMARY

The disclosure provides a charging method adapted to an electronic device including a battery module and a controller. The charging method includes: determining whether the electronic device is in a battery mode; and in response to the electronic device being in the battery mode, determining a current system state of the electronic device and accordingly setting a corresponding power consumption threshold value.

The disclosure also provides an electronic device including a battery module and a controller. The battery module is configured to power the electronic device. The controller is coupled to the battery module and configured to determine whether the electronic device is in a battery mode. In response to the electronic device being in the battery mode, the controller determines a current system state of the electronic device and accordingly sets a corresponding power consumption threshold value.

Based on the above, the electronic device and the charging method thereof of the disclosure dynamically adjusts a power consumption limit according to the current system state of the electronic device. In this way, the power consumption (output current) is limited to the most appropriate threshold value for each of the system states, such that the occurrence of abnormal conditions is determined in advance. Charging function is provided while the safety of the component of the device is taken into account.

In order to make the aforementioned features and advantages of the disclosure more comprehensible, embodiments accompanied with figures are described in detail below.

### BRIEF DESCRIPTION OF THE DRAWINGS

FIG. 1 is a block schematic view of an electronic device according to an embodiment of the disclosure.

FIG. 2 is a flow chart of a charging method according to an embodiment of the disclosure.

FIG. 3 is a flow chart of a charging method according to an embodiment of the disclosure.

### DESCRIPTION OF THE EMBODIMENTS

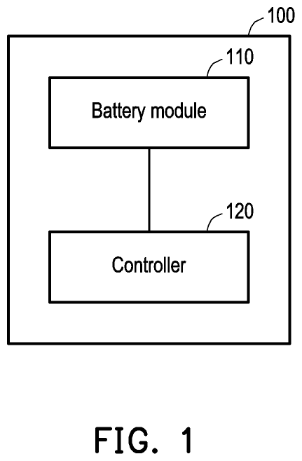

Referring to FIG. 1, the electronic device 100 of the embodiment is, for example, a portable electronic product with a USB port, such as a notebook computer and a tablet computer. The electronic device 100 includes a battery module 110 and a controller 120.

The battery module 110 may be configured to power the electronic device 100 and may be built-in or external. The battery module 110 includes, for example, a battery cell pack and a control circuit. The battery cell pack is formed by, for example, single or multiple battery cells (battery cell monomer). The control circuit includes, for example, a battery gauge chip, which may calculate stored power and output current of the battery module 110.

The controller 120 is coupled to the battery module 110. The controller 120 is, for example, a programmable chip such as an embedded controller (EC) or a microcontroller that communicates with the battery module 110 via a communication protocol. The communication protocol is, for example, a system management bus (SMBus) or an inter-integrated circuit (I²C), but the embodiment is not limited thereto.

The controller 120 dynamically adjusts the power consumption limit of the electronic device 100 according to the current system state of the electronic device 100, thereby protecting the component of the device. An embodiment is provided hereinafter to elaborate the charging method of the disclosure.

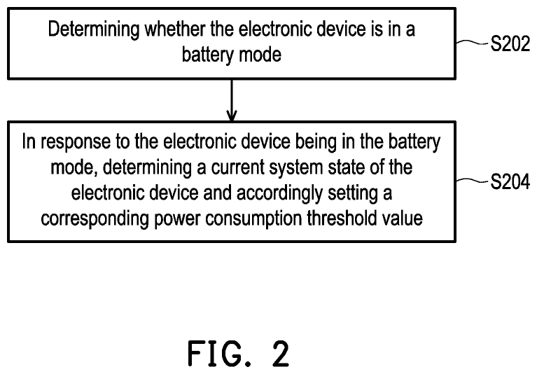

Referring to FIG. 1 and FIG. 2 at the same time, the charging method of this embodiment is adapted to the electronic device 100 of FIG. 1, and the steps are described as follows.

First, in step S202, the controller 120 determines whether the electronic device 100 is in a battery mode (DC mode). In this embodiment, the battery mode refers to a state in which the power adapter (e.g., an AC adapter) is not inserted into the power input interface of the electronic device 100, and the electronic device 100 is powered by the battery module 110 exclusively.

Next, in step S204, in response to the electronic device 100 being in the battery mode, the controller 120 determines a current system state of the electronic device 100 and accordingly sets a corresponding power consumption threshold value. In this embodiment, system state, for example, refers to one of S0 state, S3 state, modern standby (MS) state, and S5 state specified by the advanced configuration and power interface.

In this embodiment, it can be considered whether the USB port installed on the electronic device 100 has the function of charging external devices under each of the states, so as to appropriately formulate the power consumption threshold value corresponding to each of the system states in advance. The following Table 1 describes the specification and function of the USB port installed on the electronic device 100 as an example.

TABLE 1

| | USB | | | |
|---|---|---|---|---|
| | | [USB2] | [USB3] | [USB4] |
| | [USB1] | Type-C | Type-C | Type-A |
| States | Type-A | (CC/TBT) | (TBT + PD) | (QC 3.0) |
| Battery | Not charging | Not charging | Not charging | Charging |
| mode + S5 | | | | |
| Battery | Charging | Charging | Charging | Charging |
| mode + MS/S3 | | | | |

Table 1 lists the specifications and functions of the USB transmission ports USB1-USB4 installed on four electronic devices 100. USB1 and USB4 are Type-A specifications, and USB2 and USB3 are Type-C specifications. As shown in Table 1, in response to the battery mode and the S5 state being entered at the same time, the USB transmission ports USB1-USB3 do not have the charging function, and only USB4 has the charging function. On the other hand, in response to the battery mode and the MS state or S3 state being entered at the same time, the USB transmission ports USB1-USB4 all have the charging function. In this way, appropriate power consumption threshold value for each of the system states may be formulated by considering the charging requirements under each of the system states and the inherent power consumption under each of the system states. Generally speaking, a power consumption threshold value under S5 state may be set lower than a power consumption threshold value under MS state and S3 state, and a power consumption threshold value under MS state and S3 state may be set lower than a power consumption threshold value under S0 state.

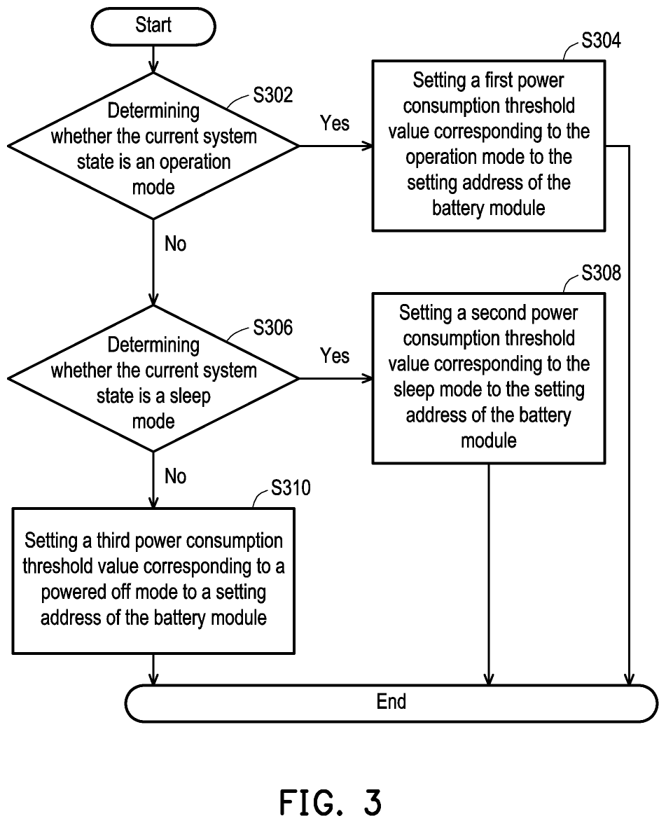

For example, the controller 120 may obtain the current system state of the electronic device 100 from a processor in the electronic device 100. For details of setting the corresponding power consumption threshold value, please refer to the steps in FIG. 3.

Referring to FIG. 1 and FIG. 3 at the same time, first, in step S302, the controller 120 determines whether the current system state of the electronic device 100 is an operation mode. In the disclosure, the operation mode may be regarded as the S0 state that may perform various operations normally.

In response to the current system state of the electronic device 100 being the operation mode, in step S304, the controller 120 sets a first power consumption threshold value corresponding to the operation mode to a setting address of the battery module 110. In this embodiment, the setting address of the battery module 110 corresponds to the number and type of I/O ports related to the electronic device 100 in the controller 120. The first power consumption threshold value is, for example, a normal power supply wattage of the battery module 110, which corresponds to an output current preset by a protection mechanism of the battery module 110. In actual operation, the controller 120 may write the first power consumption threshold value into a register of the setting address (e.g., 0x91), so as to substitute into the following hexadecimal formula (1):

0xFFFF−+1 Formula (1)

T is a value written to the register of the setting address.

In response to the current system state of the electronic device 100 not being the operation mode, in step S306, the controller 120 determines whether the current system state is a sleep mode. In the disclosure, the sleep mode may be regarded as the MS state or the S3 state that saves power by stopping most components from working.

In response to the current system state of the electronic device 100 being the sleep mode, in step S308, the controller 120 sets a second power consumption threshold value corresponding to the sleep mode to the setting address of the battery module 110. The second power consumption threshold value should be lower than the first power consumption threshold value and within a range that exceeds a rating but does not reach the protection mechanism of the battery module 110. In actual operation, to set the second power consumption threshold value to 40 watts, the controller 120 may write 0xF060 corresponding to 40 watts into the register of the setting address (e.g., 0x91), so as to substitute into the above Formula (1). The calculation formula is as follows:

0xFFFF−0xF060+1=0xF9F+1=0xFA0=4000

In response to the current system state of the electronic device 100 not being the sleep mode, in step S310, the controller sets a third power consumption threshold value corresponding to a powered off mode to the setting address of the battery module 110. The third power consumption threshold value should be lower than the second power consumption threshold value and within a range that exceeds a rating but does not reach the protection mechanism of the battery module 110. In the disclosure, the powered off mode may be regarded as the S5 state. In actual operation, to set the third power consumption threshold value to 20 watts, the controller 120 may write a hexadecimal value 0xF830 corresponding to 20 watts into the register of the setting address (e.g., 0x91), so as to substitute into the above Formula (1). The calculation formula is as follows:

0xFFFF−0xF830+1=0x7CF+1=0x7D0=2000

In addition, in step S202 of FIG. 2, in response to the electronic device 100 being determined not to be in the battery mode, the controller 120 does not make any adjustment to the power consumption limit of the electronic device 100.

Through the above charging method, the power consumption limit is dynamically adjusted according to the current system state of the electronic device 100, so that the power consumption (output current) is appropriately limited under each of the system states. Charging function is provided while the safety of the component of the device is taken into account; damage is avoided and a better protection mechanism is achieved.

In an embodiment, after executing the step S202 in FIG. 2, the controller 120 determines continuously whether a power consumption of the electronic device 100 exceeds the corresponding power consumption threshold value in a set time. The controller 120 closes a current transmission of the battery module 110 in response to the power consumption of the electronic device 100 exceeding the corresponding power consumption threshold value in the set time. Specifically, in response to the power consumption of the electronic device 100 continues to exceed the power consumption threshold value set corresponding to the current system state within the set time (e.g., seconds), The controller 120 may turn off an output transistor in the battery module 110 that controls the current transmission to stop the continued current transmission from the battery module 110.

After that, until a power adapter is inserted to withdraw the electronic device 100 from the battery mode, the controller 120 turns on the current transmission of the battery module 110 again (i.e., turns on the output transistor in the battery module 110) and restores a power consumption threshold value of the electronic device 100 to a default value. Regarding the restoring method of the power consumption threshold value, for example, the default value is also set to the setting address of the battery module 110, which is similar to the setting method of the aforementioned embodiment, and thus is not repeated herein.

It should be noted that although in this embodiment the power consumption threshold value is set and compared, in practical applications, the set power consumption threshold value may be arbitrarily converted into a threshold value for output current. The output current of the battery module 110 is detected according to the teaching of the disclosure, thereby realizing the protection mechanism.

To sum up, the electronic device and the charging method thereof of the disclosure dynamically adjusts the power consumption limit according to the current system state of the electronic device. In this way, the power consumption (output current) is limited to the most appropriate threshold value for each of the system states. By planning for protection ranges that exceed a rating but does not reach the protection mechanism of the battery, abnormal conditions are determined in advance to reduce damage from high currents.

What is claimed is:

1. A charging method, adapted to an electronic device comprising a battery module, wherein the method comprises:
determining whether the electronic device is in a battery mode; and
in response to the electronic device being in the battery mode, determining a current system state of the electronic device and accordingly setting a corresponding power consumption threshold value.

2. The charging method according to claim 1, wherein determining the current system state of the electronic device and accordingly setting the corresponding power consumption threshold value comprises:
determining whether the current system state is an operation mode;
in response to the current system state being the operation mode, setting a first power consumption threshold value corresponding to the operation mode to a setting address of the battery module; and
in response to the current system state not being the operation mode, determining whether the current system state is a sleep mode.

3. The charging method according to claim 2, wherein determining the current system state of the electronic device and accordingly setting the corresponding power consumption threshold value further comprises:
in response to the current system state being the sleep mode, setting a second power consumption threshold value corresponding to the sleep mode to the setting address of the battery module, wherein the second power consumption threshold value is lower than the first power consumption threshold value; and
in response to the current system state not being the sleep mode, setting a third power consumption threshold value corresponding to a powered off mode to the setting address of the battery module, wherein the third power consumption threshold value is lower than the second power consumption threshold value.

4. The charging method according to claim 1, wherein after accordingly setting the corresponding power consumption threshold value, the method further comprises:
determining continuously whether a power consumption of the electronic device exceeds the corresponding power consumption threshold value in a set time; and
switching off a current transmission of the battery module in response to the power consumption of the electronic device exceeding the corresponding power consumption threshold value in the set time.

5. The charging method according to claim 4, further comprising:
in response to a power adapter being inserted to withdraw the electronic device from the battery mode, turning on the current transmission of the battery module, and restoring a power consumption threshold value of the electronic device to a default value.

6. An electronic device, comprising:
a battery module, configured to power the electronic device; and
a controller, coupled to the battery module and configured to determine whether the electronic device is in a battery mode,
wherein in response to the electronic device being in the battery mode, the controller determines a current system state of the electronic device and accordingly sets a corresponding power consumption threshold value.

7. The electronic device according to claim 6, wherein the controller determines whether the current system state is an operation mode, in response to the current system state being the operation mode, the controller sets a first power consumption threshold value corresponding to the operation mode to a setting address of the battery module,
and in response to the current system state not being the operation mode, the controller determines whether the current system state is a sleep mode.

8. The electronic device according to claim 7, wherein in response to the current system state being the sleep mode, the controller sets a second power consumption threshold value corresponding to the sleep mode to the setting address of the battery module, wherein the second power consumption threshold value is lower than the first power consumption threshold value,
and in response to the current system state not being the sleep mode, the controller sets a third power consumption threshold value corresponding to a powered off mode to the setting address of the battery module, wherein the third power consumption threshold value is lower than the second power consumption threshold value.

9. The electronic device according to claim 6, wherein the controller determines continuously whether a power consumption of the electronic device exceeds the corresponding power consumption threshold value in a set time,
the controller switches off a current transmission of the battery module in response to the power consumption of the electronic device exceeding the corresponding power consumption threshold value in the set time.

10. The electronic device according to claim 9, wherein in response to a power adapter being inserted to withdraw the electronic device from the battery mode, the controller turns on the current transmission of the battery module and restores a power consumption threshold value of the electronic device to a default value.
